(19) United States
(12) Patent Application Publication
(10) Pub. No.: US 2015/0328561 A1
(43) Pub. Date: Nov. 19, 2015

(54) METHODS FOR SEPARATING BIO-OILS

(71) Applicant: Battelle Energy Alliance, LLC, Idaho Falls, ID (US)

(72) Inventors: Daniel M. Ginosar, Idaho Falls, ID (US); Lucia M. Petkovic, Idaho Falls, ID (US); Deborah T. Newby, Idaho Falls, ID (US)

(73) Assignee: Battelle Energy Alliance, LLC, Idaho Falls, ID (US)

(21) Appl. No.: 14/280,026

(22) Filed: May 16, 2014

(51) Int. Cl. B01D 11/04

(52) U.S. Cl. CPC B01D 11/0407; B01D 11/0488; B01D 11/0492

(57) ABSTRACT

Methods of separating a bio-oil are disclosed. The method comprises contacting a bio-oil with a supercritical alkane to dissolve non-polar compounds of the bio-oil in the supercritical alkane. The bio-oil is produced from a biomass by a thermochemical process. The non-polar compounds are removed from the bio-oil to produce a fractionated bio-oil comprising polar compounds.

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### TECHNICAL FIELD

The disclosure, in various embodiments, relates generally to chemistry and to methods of separating bio-oils. More specifically, the disclosure, in various embodiments, relates to using supercritical fluids to separate the bio-oils.

### BACKGROUND

Bio-oils are promising sources of sustainable, low greenhouse gas (GHG) alternative fuels. Bio-oils are complex compositions and include mixtures of numerous compounds such as carbohydrates, proteins, lipids, and water. For instance, bio-oils include high levels of oxygen-containing compounds, such as alcohols, ethers, aldehydes, ketones, phenols, esters, guaiacols, syringols, sugars, furans, and carboxylic acids. The oxygen-containing compounds cause the bio-oils to be polar and, thus, immiscible with petroleum fuels, which are non-polar. Bio-oils also have limited solubility in water. Bio-oils also contain non-oxygen-containing compounds, such as alkanes, alkenes, aromatics, and nitrogen-containing compounds. The bio-oils are potential precursors to fuels but do not have the same chemical compositions and physical properties as petroleum fuels. Thus, the bio-oils are not drop-in replacements for petroleum fuels. Bio-oils have been produced from a variety of biomass feedstocks, such as from woody biomass, crop residues, and algae, by thermochemical conversion of the biomass. The biomass feedstocks are renewable, have little or no carbon dioxide (CO₂) or GHG emissions, and are less capital intensive than fossil fuels. By increasing reliance on renewable feedstocks to produce bio-oils, reliance on foreign petroleum may be reduced.

Bio-oils produced from biomass feedstocks have problems with thermal stability and aging, making the bio-oils difficult to transport and store. Due to their acidity and high content of oxygen-containing compounds, the bio-oils are unstable when stored at ambient or higher temperature. The high water and oxygen content of the bio-oils lead to esterification and etherification reactions, as well as polymerization and condensation reactions that increase the viscosity of the bio-oils. Thus, bio-oils are not attractive as drop-in replacements for petroleum fuels.

Since the bio-oils are viscous, acidic, reactive, and thermally unstable, their separation is also difficult. The separation of bio-oils into different fractions has been attempted by numerous techniques, such as solvent extraction, centrifugation, vacuum distillation, column chromatography, and membrane-based processes. Due to the large number of types of compounds in the bio-oils, the presence of water, and the large proportion of oxygen-containing compounds, the separation of bio-oils into stable fractions is problematic. While solvent extraction is effective, large amounts of energy are utilized to remove the solvent from the resulting extract, and the solvent becomes contaminated with minerals from char or ash present in the bio-oils.

Supercritical carbon dioxide (CO₂) has been used in a batch process to separate a bio-oil produced from wheat and wood biomass. The bio-oil was extracted with supercritical CO₂ under batch conditions at constant temperature and pressure for three consecutive 2-hour extractions for the first three fractions. Then, the pressure was increased for the fourth extraction. The four fractions were collected at ambient pressure. While water was effectively removed from the bio-oil in each extraction, each fraction contained oxygen-containing compounds.

Algal feedstocks for bio-oils are particularly promising because algae are one of the fastest growing plants in the world. Algae have a faster growth rate and productivity than growth of conventional terrestrial crops. The grown algae provide high-energy area yields and require less land to grow than conventional terrestrial crops. The algae can also be cultivated in non-arable areas, such as in fresh water, brackish water, salt water, or waste water.

It would be desirable to separate bio-oils by an energy efficient process, so that the bio-oils may be more easily transported and stored.

### BRIEF SUMMARY

An embodiment of the disclosure includes a method of separating a bio-oil. The method comprises contacting a bio-oil produced from a biomass by a thermochemical process with a supercritical alkane to dissolve non-polar compounds of the bio-oil in the supercritical alkane. Non-polar compounds are removed from the bio-oil to produce a fractionated bio-oil comprising polar compounds.

Another embodiment of the disclosure includes a method of separating a bio-oil. The method comprises converting a biomass into bio-oil by a thermochemical process. The bio-oil is contacted with a supercritical alkane to remove non-polar compounds from the bio-oil. The bio-oil is contacted with supercritical carbon dioxide to remove water and polar compounds from the bio-oil. The polar compounds are recovered from the supercritical carbon dioxide.

### BRIEF DESCRIPTION OF THE DRAWINGS

FIG. 1 is a system used to separate bio-oils using a supercritical alkane according to an embodiment of the disclosure;

FIG. 2 is a system used to separate bio-oils using a supercritical alkane and supercritical carbon dioxide according to an embodiment of the disclosure;

FIG. 3 is a graph showing the amount of bio-oil extracted using supercritical propane at different temperatures (25° C., 40° C., 65° C., 110° C.);

FIG. 4 is a graph showing the amount of bio-oil extracted and recovered using supercritical propane at different temperatures (25° C., 40° C., 65° C., 110° C.);

FIGS. 5 and 6a-6c are infrared (IR) spectroscopy data and gas chromatography/mass spectrometry (GC/MS) data of some of the bio-oil samples in Example 3;

FIG. 7 is a graph showing the amount of bio-oil extracted using supercritical propane for different pyrolysis processes;

FIG. 8 is a graph showing the amount of bio-oil extracted using supercritical carbon dioxide for different pyrolysis processes;

FIG. 9 shows IR spectroscopy data of bio-oil fractions extracted using supercritical carbon dioxide and supercritical propane;

FIG. 10 shows IR spectroscopy data of parent bio-oil, supercritical propane extracted bio-oil, and raffinate samples;

FIG. 11 shows ¹³C NMR analyses of parent bio-oil, supercritical propane extracted bio-oil, and raffinate samples;

FIG. 12 shows ¹H NMR analyses of parent bio-oil, supercritical propane extracted bio-oil, and raffinate samples;

FIG. 13 shows MALDI-TOF data of parent bio-oil, supercritical propane extracted bio-oil, and raffinate samples;

FIG. 14 shows thermogravimetric analysis (TGA) data of parent bio-oil, supercritical propane extracted bio-oil, and raffinate samples;

FIGS. 15A-15C shows IR analyses on fresh and aged (24 hours and 2 weeks) samples of the parent bio-oil, supercritical propane extracted bio-oil, and raffinate;

FIGS. 16A-16C shows MALDI-TOF analyses on fresh and aged (24 hours and 2 weeks) samples of the parent bio-oil, supercritical propane extracted bio-oil, and raffinate;

FIGS. 17A-17C shows TGA analyses on fresh and aged (24 hours and 2 weeks) samples of the parent bio-oil, supercritical propane extracted bio-oil, and raffinate;

FIGS. 18 and 19 shows ¹³C NMR analyses of bio-oil and supercritical propane extracted bio-oil; and

FIG. 20 shows ¹H NMR analyses of bio-oil and supercritical propane extracted bio-oil.

### DETAILED DESCRIPTION

Methods of separating (e.g., fractionating) a bio-oil are disclosed. The bio-oil is produced from biomass (e.g., a biomass feedstock) by a thermochemical process. To fractionate the bio-oil, the bio-oil is contacted with a supercritical alkane, or sequentially contacted with the supercritical alkane and supercritical carbon dioxide (CO₂). Following contact with the supercritical fluid(s), the bio-oil is separated into at least two fractions, a fraction having polar compounds and a fraction having non-polar compounds. As used herein, the terms “polar” and “non-polar” refer to relative polarities of compounds within the bio-oil, and not to absolute polarities of the compounds. For instance, less polar compounds may dissolve into the supercritical fluid while more polar compounds remain in the bio-oil. The supercritical fluid containing the non-polar compounds may then be separated from the bio-oil. Following removal of the non-polar compounds, the fraction having the polar compounds is more stable to heat and oxidation relative to the bio-oil (e.g., non-fractionated bio-oil). The fraction having the polar compounds may also be substantially free of water. The compounds in the different fractions of the bio-oil may be further isolated and recovered, for use as commodity chemicals or may be converted (e.g., upgraded) to a fuel. Since the fractionated bio-oil is more stable to heat and oxidation, the processes of the present disclosure may be used to increase the stability of bio-oils for transport and storage.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the term “bio-oil” means and includes a liquid product produced from biomass by a thermochemical process. By way of example only, the biomass may be a plant derived material, such as algae, agricultural residues (cotton stalks, corn straw, corn cobs, rice husk, rice straw, maize stalks, etc.), forestry residues (sawdust, bark, shavings, etc.), industrial byproducts (grape seeds/skins, lignin, etc.).

As used herein, the term “algae” means and includes unicellular or multicellular, prokaryotic or eukaryotic organisms capable of harvesting solar energy and converting CO₂ and water to oxygen (O₂). The algae may be a naturally occurring species, a genetically selected strain, a genetically manipulated strain, a transgenic strain, or a synthetic algae. The algae include, but are not limited to, microalgae (unicellular eukaryotic organisms), macroalgae (e.g., seaweeds), and cyanobacteria. The algae may include, but are not limited to, organisms in the following genuses: Chlorella, Spirulina, Phaeophyta, Coelastrum, Micractinium, Nannochloropsis, Porphyridium, Nostoc, Haematococcus, Chlorophyta, Rhodophyta, Dunaliella, Scenedesmus, Micro cystis, Synechocystis, Anabaena, or Chlamydomonas. In one embodiment, the bio-oil was generated from Scenedesmus biomass. The algal feedstock may include a biomass generated by growth of a single species or strain of algae, or of a combination of strains, such as those grown in a polyculture. In the case of a polyculture, the presence of bacteria or other organisms grown in the presence of the algae may contribute to the biomass. Properties of the algal feedstock that are likely to improve the quantity or quality of the bio-oil may include low ash content and high lipid content.

As used herein, the term “supercritical fluid” is used to refer to a fluid that is pressurized above atmospheric pressure at a temperature between the boiling temperature and critical temperature (T_{c}) of the fluid or that is pressurized at or above a critical pressure (P_{c}) at a temperature at or above the T_{c}. The temperature and pressure conditions used to maintain the fluid at or near its T_{c} and at or near its P_{c} depend on the fluid being used. The temperature and pressure may be slightly below each of the T_{c} and P_{c} of the fluid so long as the fluid exhibits properties similar to those in the critical phase. To keep the fluid at or near its T_{c}, the temperature of the fluid may be maintained in a range of from approximately 75° C. below the T_{c} of the fluid to approximately 75° C. above the T_{c} of the fluid. To keep the fluid at or near its P_{c}, the pressure of the fluid may range from approximately 0.1 times its P_{c} to approximately 10 times its P_{c}, such as greater than or equal to 0.5 times the P_{c}. Thus, the term “supercritical fluid” also includes a fluid maintained at a near-critical temperature and pressure condition, where the temperature is greater than or equal to 0.9 times the T_{c} and/or the pressure is greater than or equal to 0.5 times the P_{c}.

Following the thermochemical process, the bio-oil may include multiple compounds of differing polarities, such as proteins, lipids, water, carbohydrates, and other oxygen-containing compounds. The oxygen-containing compounds may include, but are not limited to alcohols, ethers, aldehydes, ketones, phenols, esters, guaiacols, syringols, furans, and carboxylic acids. The chemical composition of each bio-oil depends on the nature of the biomass and thermochemical process used. By appropriately selecting the biomass and the conditions of the thermochemical process, a bio-oil having a high lipid content may be produced.

The bio-oil may be produced from the biomass feedstock by a thermochemical process including, but not limited to, a fast pyrolysis process, a catalytic pyrolysis process, such as a fluid catalytic cracking (FCC) process, a hydrothermolysis (HTL) process, or a torrefaction process. Such thermochemical processes are known in the art, as are processes for producing bio-oils from biomass (e.g., algal) feedstocks by these processes, and, therefore, are not described in detail herein. The thermochemical process may be conducted at a temperature of between about 150° C. and about 600° C. In one embodiment, the bio-oil is produced from an algal feedstock by the thermochemical process.

Following the thermochemical process, the bio-oil includes non-polar compounds, such as alkanes, alkenes, aromatics, and nitrogen-containing compounds, and polar compounds, such as oxygen-containing compounds. The oxygen-containing compounds, such as alcohols, ethers, aldehydes, ketones, phenols, esters, guaiacols, syringols, sugars, furans, and carboxylic acids, cause the bio-oil to be polar and have limited solubility in water. The bio-oil also includes water and char.

The bio-oil may be separated by contacting the bio-oil with a supercritical alkane. The supercritical alkane may be a C₂-C₆ alkane, such as ethane, propane, butane, pentane, hexane, isomers thereof (e.g., n-butane, isobutane, t-butane, n-pentane, isopentane), or combinations thereof. In one embodiment, the supercritical alkane is near-critical propane. As known in the art, propane has a critical pressure of 4.25 MPa and a critical temperature of 96.7° C. The supercritical alkane may dissolve the non-polar (e.g., lower polarity) compounds of the bio-oil while the polar (e.g., higher polarity) compounds may be substantially insoluble in the supercritical alkane and, thus, remain in the bio-oil. The non-polar compounds include, but are not limited to, the alkane compounds, alkene compounds, aromatic compounds, nitrogen-containing compounds, or combinations thereof. As described above, the non-polar compounds and polar compounds refer to the relative polarities of the compounds, and not to absolute polarities of the compounds. The supercritical alkane including the non-polar compounds may be separated from the bio-oil by conventional techniques, such as by distillation, decanting, liquid-liquid separation, gravity separation, centrifugal separation, or other fluid separation techniques. Following the separation, the bio-oil is depleted of the non-polar compounds and is referred to herein as “fractionated bio-oil.” The polar compounds remaining in the fractionated bio-oil may include water-soluble organic compounds (e.g., the oxygen-containing compounds), water, and a minor amount of char. The oxygen-containing compounds may include, but are not limited to, alcohol compounds, ether compounds, aldehyde compounds, ketone compounds, phenol compounds, ester compounds, guaiacol compounds, syringol compounds, sugar compounds, furan compounds, carboxylic acid compounds, or combinations thereof. The fractionated bio-oil may also include inorganic compounds and solids because the supercritical alkane has only moderate density, low viscosity, and no surface tension. Thus, the supercritical alkane containing the non-polar compounds and the fractionated bio-oil may be chemically different from one another. The non-polar compounds in the supercritical alkane may be further fractionated into similar polarity-containing fractions, such as an aromatic-rich hydrocarbon fraction and an alkane-rich hydrocarbon fraction by adjusting at least one of the pressure and temperature at which the alkane is maintained. The alkane may be subjected to changes in pressure and temperature, such as decreasing at least one of the pressure and temperature, to a pressure or temperature below the critical point of the alkane. The changes in pressure or temperature cause non-polar compounds having similar polarities to drop out of the alkane. By conducting multiple acts of decreasing at least one of the pressure and temperature conditions, similar polarity-containing fractions of the non-polar compounds may be separated from the supercritical alkane and recovered. The recovered compounds having similar polarities may have economic value, such as being sold for use as commodity chemicals.

The fractionated bio-oil containing the polar compounds may, optionally, be contacted with supercritical carbon dioxide (CO₂) for further separation of the polar compounds. As known in the art, CO₂ has a critical pressure of 7.38 MPa and a critical temperature of 31.1° C. Contact with the supercritical CO₂ may dissolve the water-soluble organic compounds in the supercritical CO₂, while the water and char remain in the fractionated bio-oil. To further improve the separation, the supercritical CO₂ may, optionally, be modified with a polar co-solvent, such as water, methanol, ethanol, propanol, or combinations thereof. If present, the co-solvent may account for from about 1% by weight (wt %) to about 15 wt %, such as from about 2 wt % to about 5 wt %, of a total weight of the supercritical fluid (the supercritical carbon dioxide plus the co-solvent).

The supercritical CO₂ containing the water-soluble organic compounds may be further fractionated into similar polarity-containing fractions by changing the pressure and temperature conditions at which the supercritical CO₂ is maintained. The supercritical CO₂ may be subjected to changes in pressure and temperature, such as decreasing at least one of the pressure and temperature, to a pressure or temperature below the critical point of CO₂. The changes in pressure or temperature cause compounds having similar polarities to one another to drop out of the supercritical CO₂. By way of example only, the supercritical CO₂ containing the water-soluble organic compounds may be separated into separate fractions of organic acids, alcohols/aldehydes/ketones, and other oxygen-containing compounds.

By separating the water-soluble organic compounds into fractions with similar polarities, the resulting fractions may exhibit increased thermal stability compared to that of the bio-oil. The fractions containing compounds having similar polarities may be separated from the supercritical CO₂ and recovered. Since the water-soluble organic compounds of each fraction are similar to one another in polarity, the compounds may be substantially non-reactive with one another. The recovered fractions containing the different polar compounds, such as oxygen-containing compounds, may be upgraded to fuels. The recovered fractions, which now have increased stability, may be transported to a refinery for the upgrading to a fuel by a hydrotreating process, a hydrocracking process, or a fluid catalytic cracking (FCC) process. The oxygen-containing compounds may be converted to a fuel using a hydrotreater or a hydrocracker. In addition, by removing the water-soluble organic compounds from the supercritical carbon dioxide, the carbon dioxide may be liquefied and recycled. The water and inorganic compounds removed from the bio-oil may also be recycled, such as used as nutrients in processes for producing the biomass. Any char may be recovered and sold as a soil amendment.

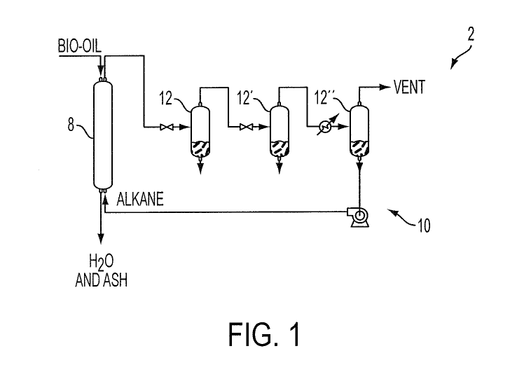

A system 2 for separating bio-oil using a supercritical alkane is schematically shown in FIG. 1. The system 2 includes extractor 8, pump 10, and separators 12, 12′, 12″, in addition to vessels (not shown) configured to receive and store the bio-oil produced from the biomass feedstock and configured to receive and store the alkane in its supercritical state. The vessel for storing the bio-oil may be a conventional vessel compatible for use with the bio-oil and is not described in detail herein. The bio-oil may be heated to a temperature of about 65° C. and introduced into the extractor 8, such as by using a pump (not shown). The pump may be a conventional pump, which is not described in detail herein.

The vessel for storing the alkane may be configured to receive and store the alkane in its supercritical state. The alkane may be stored in the vessel under temperature and pressure conditions sufficient to maintain the alkane as a supercritical alkane. The flow rate of the supercritical alkane into the extractor 8 may be sufficient to dissolve the non-polar (e.g., low polarity) compounds of the bio-oil. The supercritical alkane may be introduced into the extractor 8 using a pump (not shown). The pump may be a conventional pump, which is not described in detail herein.

The extractor 8 may be a conventional extraction column, which is not described in detail herein. By way of example only, the extractor 8 may be a continuous countercurrent multistage extraction column. The extractor 8 is configured so that the contents of the extractor 8 may be heated and pressurized, such as to temperatures and pressures at or above the T_{c} and P_{c} of the alkane. In an embodiment where the alkane is propane, the bio-oil and the supercritical alkane may be heated to a temperature of about 65° C. and pressurized to about 35 bar before contacting one another in the extractor 8. The bio-oil and the supercritical alkane may contact one another in the extractor 8, with the supercritical alkane dissolving the non-polar (e.g., lower polarity) compounds from the bio-oil while the polar (e.g., higher polarity) compounds are substantially insoluble in the supercritical alkane and remain in the bio-oil. The supercritical alkane and the bio-oil may flow through the extractor 8 counter current to one another. The supercritical alkane may be present at from about 10% by volume to greater than about 99% by volume relative to the volume of the bio-oil.

The non-polar compounds include, but are not limited to, the alkanes, alkenes, aromatics, nitrogen-containing compounds, or combinations thereof. As described above, the non-polar compounds and polar compounds refer to relative polarities of the compounds, and not to absolute polarities of the compounds. The supercritical alkane and the bio-oil may exit the extractor 8 and be transported to a separator 12, where the supercritical alkane containing the non-polar compounds and the bio-oil containing the polar compounds are separated by conventional techniques, which are not described in detail herein. By way of example only, the separator 12 may be a conventional vapor recompression distillation column, which is not described in detail herein. Since the non-polar compounds are removed from the bio-oil, the bio-oil is consequently referred to herein as a “fractionated bio-oil.”

The polar compounds remaining in the fractionated bio-oil may include water-soluble organic compounds (e.g., the oxygen-containing compounds), water, and a minor amount of char. The oxygen-containing compounds may include, but are not limited to, alcohols, ethers, aldehydes, ketones, phenols, esters, guaiacols, syringols, sugars, furans, carboxylic acids, or combinations thereof. The fractionated bio-oil may also include inorganic compounds and solids because the supercritical alkane has only moderate density, low viscosity, and no surface tension. The fractionated bio-oil may be transported to additional separators 12′, 12″ to further separate the fractionated bio-oil containing the polar compounds into similar polarity-containing fractions, such as separate fractions of organic acids, alcohols/aldehydes/ketones, and other oxygen-containing compounds. The further separation of the fractionated bio-oil may be conducted by adjusting at least one of the pressure and temperature at which the fractionated bio-oil is maintained in the additional separators 12′, 12″. The additional separators 12′, 12″ may also be vapor recompression distillation columns, which are connected in series with separator 12. The changes in pressure and temperature cause similar polarity compounds of the polar compounds to drop out of the fractionated bio-oil. Moderate changes in temperature or pressure may be used to change the solubility of the polar compounds with similar polarities, enabling the polar compounds to be easily separated from one another. Since only moderate temperature or pressure changes are needed, the method of separating the bio-oil of the present disclosure may be both cost effective and energy efficient. The different fractions of polar compounds may be recovered from the separators 12, 12′, 12″ and transported to an extract receiver (not shown) maintained at ambient pressure and temperature. The desired fraction of bio-oil may be recovered from the extract receiver.

The non-polar compounds in the supercritical alkane may be further fractionated into similar polarity-containing fractions, such as an aromatic-rich hydrocarbon fraction and an alkane-rich hydrocarbon fraction by adjusting at least one of the pressure and temperature at which the alkane is maintained. The changes in pressure and temperature cause similar polarity compounds of the non-polar compounds to drop out of the supercritical alkane. The different fractions of non-polar compounds may be recovered and sold as commodity chemicals. After removing the non-polar compounds, the supercritical alkane may be reused by transporting the supercritical alkane back to the vessel configured to receive and store the alkane. The supercritical alkane may be cooled to ambient temperature, liquefied, and recycled back to the vessel, such as using a pump 10. By maintaining the pressure above the ambient temperature bubble point, a compressor may be eliminated, reducing the overall energy requirements of the system 2. A byproduct stream exiting the extractor 8 may include water and inorganic compounds and may be transported to a raffinate receiver (not shown).

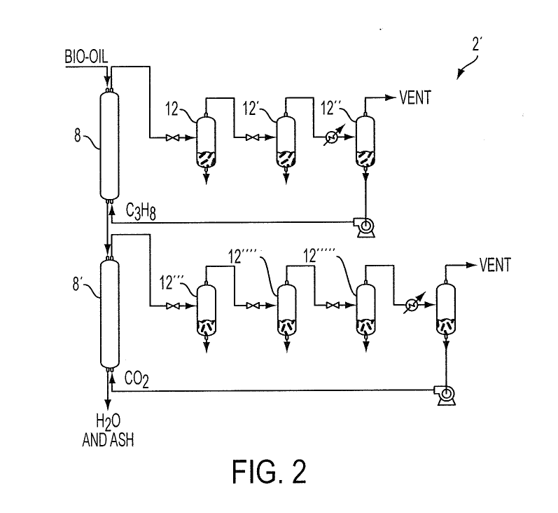

A simplified schematic for a system 2′ for separating the bio-oil using two supercritical fluids, such as a supercritical alkane and supercritical carbon dioxide, is shown in FIG. 2. The bio-oil produced by a thermochemical process as described above may be introduced into a first extractor 8. The bio-oil may include water and char in addition to the polar and non-polar compounds. A supercritical alkane, such as supercritical propane, may be introduced into the first extractor 8 and contacted with the bio-oil. The supercritical alkane and the bio-oil may flow through the extractor 8 counter current to one another. The supercritical alkane may be present at from about 10% by volume to greater than about 99% by volume relative to the volume of the bio-oil. The flow rate of the supercritical alkane into the first extractor 8 may be sufficient to dissolve the non-polar (e.g., low polarity) compounds of the bio-oil. The supercritical alkane may dissolve the non-polar (e.g., low polarity) compounds of the bio-oil while the polar (e.g., high polarity) compounds are substantially insoluble in the supercritical alkane and remain in the bio-oil. The non-polar compounds may include, but are not limited to, alkanes, alkenes, and aromatics. The supercritical alkane and the bio-oil may be separated by conventional techniques, which are not described in detail herein. Since the non-polar compounds are removed from the bio-oil, the bio-oil is consequently referred to herein as a “fractionated bio-oil.”

The polar compounds remaining in the fractionated bio-oil may include water-soluble organic compounds (e.g., oxygen-containing compounds), water, and a minor amount of char. The fractionated bio-oil may also include inorganic compounds and solids. Thus, the supercritical alkane containing the non-polar compounds and the fractionated bio-oil containing the water-soluble organic compounds may be chemically different from one another.

The supercritical alkane having the dissolved non-polar compounds is transported to separators 12, 12′, 12″ where the non-polar compounds may be further fractionated into similar polarity-containing fractions, such as an aromatic-rich hydrocarbon fraction and an alkane-rich hydrocarbon fraction, by adjusting at least one of the pressure and temperature at which the alkane is maintained. The changes in pressure and temperature cause similar polarity compounds of the non-polar compounds to drop out of the supercritical alkane. The different fractions of non-polar compounds may be recovered and sold as commodity chemicals. After removing the non-polar compounds, the supercritical alkane may be reused by transporting the supercritical alkane back to the first extractor 8. The supercritical alkane may be cooled to ambient temperature, liquefied, and recycled back to the first extractor 8, such as using a pump 10. By maintaining the pressure above the ambient temperature bubble point, a compressor may be eliminated from the system 2′, reducing the overall energy requirements of the process.

The fractionated bio-oil may be transported to a second extractor 8′ and contacted with supercritical carbon dioxide to further separate the polar compounds into similar polarity-containing fractions, such as separate fractions of organic acids, alcohols/aldehydes/ketones, and other oxygen-containing compounds. The supercritical carbon dioxide and the fractionated bio-oil may flow through the extractor 8 counter current to one another. The supercritical carbon dioxide may be present at from about 10% by volume to greater than about 99% by volume relative to the volume of the fractionated bio-oil. The flow rate of the supercritical carbon dioxide into the second extractor 8′ may be sufficient to dissolve the water-soluble organic compounds of the fractionated bio-oil. The supercritical carbon dioxide may be introduced into the second extractor 8′ and contacted with the fractionated bio-oil, which includes the water-soluble organic compounds, water, and char. The supercritical carbon dioxide may dissolve the water-soluble organic compounds while the water and char are substantially insoluble in the supercritical carbon dioxide. The supercritical carbon dioxide containing the water-soluble organic compounds and the fractionated bio-oil, which includes the water and char, may exit the second extractor 8′ and be transported to separator 12′″, where the supercritical carbon dioxide containing the water-soluble organic compounds is separated from the water and char by conventional techniques, which are not described in detail herein. The water and inorganic compounds exiting the second extractor 8′ may be recycled and reused, such as a nutrient for the biomass. The char may be recovered from the second extractor 8′ and sold as a soil amendment.

The supercritical carbon dioxide containing the water-soluble organic compounds may be transported to additional separators 12″″, 12′″″ to further separate the water-soluble organic compounds into similar polarity-containing fractions, such as separate fractions of organic acids, alcohols/aldehydes/ketones, and other oxygen-containing compounds. The supercritical carbon dioxide containing the water-soluble organic compounds may be further fractionated into the different polarity fractions by altering at least one of the temperature and pressure at which the supercritical carbon dioxide is maintained in the additional separators 12″″, 12′″″. The changes in pressure and temperature cause similar polarity compounds of the water-soluble organic compounds to drop out of the supercritical carbon dioxide. By way of example only, the supercritical carbon dioxide containing the water-soluble organic compounds may be separated into separate fractions of organic acids, alcohols/aldehydes/ketones, and other oxygen-containing compounds by changing the pressure and temperature to which the supercritical carbon dioxide is exposed. The different fractions of the water-soluble organic compounds may be recovered from the separators 12′″, 12″″, 12′″″. After removing the water-soluble organic compounds, the supercritical carbon dioxide may be reused by liquefying the supercritical carbon dioxide and transporting the carbon dioxide back to the second extractor 8′, such as by using a pump 10. By maintaining the pressure above the ambient temperature bubble point, a compressor may be eliminated from the system 2′, reducing the overall energy requirements of the process.

The non-polar compounds recovered from the supercritical alkane may be upgraded to a fuel or may be sold as commodity chemicals. The fractions including the recovered non-polar compounds, which now have increased stability, may be transported to a refinery for upgrading to the fuel. Since the fractions of the bio-oil are stabilized, the fractions may be transported from the field to large scale centralized facilities, such as to a petroleum refinery. The non-polar compounds may be converted (e.g., upgraded) to a fuel by a hydrotreating process, a hydrocracking process, or a fluid catalytic cracking (FCC) process.

The water-soluble organic compounds recovered from the supercritical carbon dioxide may be upgraded to a fuel or may be sold as commodity chemicals. The fractions including the recovered water-soluble organic compounds, which now have increased stability, may be transported to a refinery for upgrading to the fuel. Since each fraction has a similar polarity, the fractions may be more stabilized and resistant to thermal aging. Also, since the fractions of the bio-oil are stabilized, the fractions may be transported from the field to large scale centralized facilities, such as to a petroleum refinery. The water-soluble organic compounds may be converted (e.g., upgraded) to a fuel by a hydrotreating process, a hydrocracking process, a fluid catalytic cracking (FCC) process, a hydrodeoxygenation process, or an emulsification process, which are known in the art and, therefore, are not described in detail herein.

By separating the polar compounds into fractions with similar polarities, the resulting fractions of bio-oil may exhibit increased thermal stability compared to that of the initial bio-oil. Since the polar compounds have similar polarities to one another, the compounds may be substantially non-reactive with one another. The use of the processes of the present disclosure to separate bio-oils may be beneficial compared to liquid solvent extraction processes as energy demands in the processes of the present disclosure are reduced, and the predisposition to carry over of solids into the extracted phase is reduced. Thus, the processes of the present disclosure provide improved stability of the bio-oil with minimal energy inputs and processing costs.

In addition, since water is almost completely insoluble in the supercritical alkane and the supercritical carbon dioxide is saturated to less than 4 grams per liter of water, the process of the present disclosure may be used to remove water from (e.g., dewater) the bio-oil. The process according to the present disclosure may also be a continuous process rather than the supercritical fluid batch processes previously used, which included oxygenated products in all the fractions.

While the systems 2, 2′ described above utilize one or two supercritical fluids, it is understood that more than two supercritical fluids may be used.

The following examples serve to explain embodiments of the disclosure in more detail. These examples are not to be construed as being exhaustive or exclusive as to the scope of this disclosure.

### EXAMPLES

### Example 1

### Thermochemical Conversion of Algal Feedstock

Algae (Scenedesmus dimorphus) were grown and thermochemically converted to bio-oils using hydrothermal liquefaction (HTL), pyrolysis at 400° C., and fluid catalytic cracking (FCC) pyrolysis at 400° C. The bio-oils were subjected to elemental analysis by conventional techniques. The bio-oil produced by HTL had 68.5% C, 8.82% H, 5.76% N, and 16.9% O, a H/C molar ratio of 1.53, a N/C molar ratio of 0.07, a O/C molar ratio of 0.18, and an empirical formula of CH_{1.53}N_{0.07}O_{0.18}. The bio-oil produced by pyrolysis at 400° C. had 61.2% C, 8.35% H, 9.01% N, and 21.5% O, a H/C molar ratio of 1.63, a N/C molar ratio of 0.13, a O/C molar ratio of 0.26, and an empirical formula of CH_{1.63}N_{0.13}O_{0.26}. The bio-oil produced by FCC pyrolysis at 400° C. had 62.2% C, 8.42% H, 7.51% N, and 21.8% O, and a H/C molar ratio of 1.61, a N/C molar ratio of 0.10, a O/C molar ratio of 0.26, and an empirical formula of CH_{1.61}N_{0.10}O_{0.26}. All percentages are by weight.

### Example 2

### Thermally Stability of Bio-Oils

Baseline samples of the bio-oils from Example 1 were held at 4° C.-7° C. Thermally aged samples of the bio-oils from Example 1 were subjected to 80° C. for 24 hours. The baseline and thermally aged samples were analyzed by viscosity analysis, matrix-assisted laser desorption/ionization-time of flight (MALDI-TOF) mass spectrometry, fourier transform IR (FTIR) spectroscopy, and nuclear magnetic resonance (NMR) spectroscopy to determine differences between the baseline and thermally aged samples. The properties were determined by conventional techniques. The bio-oil produced by HTL had an average molecular weight change of 160 amu following the thermal aging, and a viscosity increase from 289 cP at 80° C. to 5900 cP at 80° C. after the thermal aging. The bio-oil produced by pyrolysis at 400° C. had an average molecular weight change of 75 amu following the thermal aging, and no substantial viscosity increase (340 cP at 80° C.). The bio-oil produced by FCC pyrolysis at 400° C. had an average molecular weight change of 82 amu following the thermal aging, and a viscosity after thermal aging of 160 cP at 80° C.

The thermal aging studies showed that the bio-oil produced by HTL was the least stable. The bio-oils produced by pyrolysis at 400° C. and FCC pyrolysis at 400° C. were more stable to thermal aging.

### Example 3

### Extraction of Bio-Oils from Algal Biomass

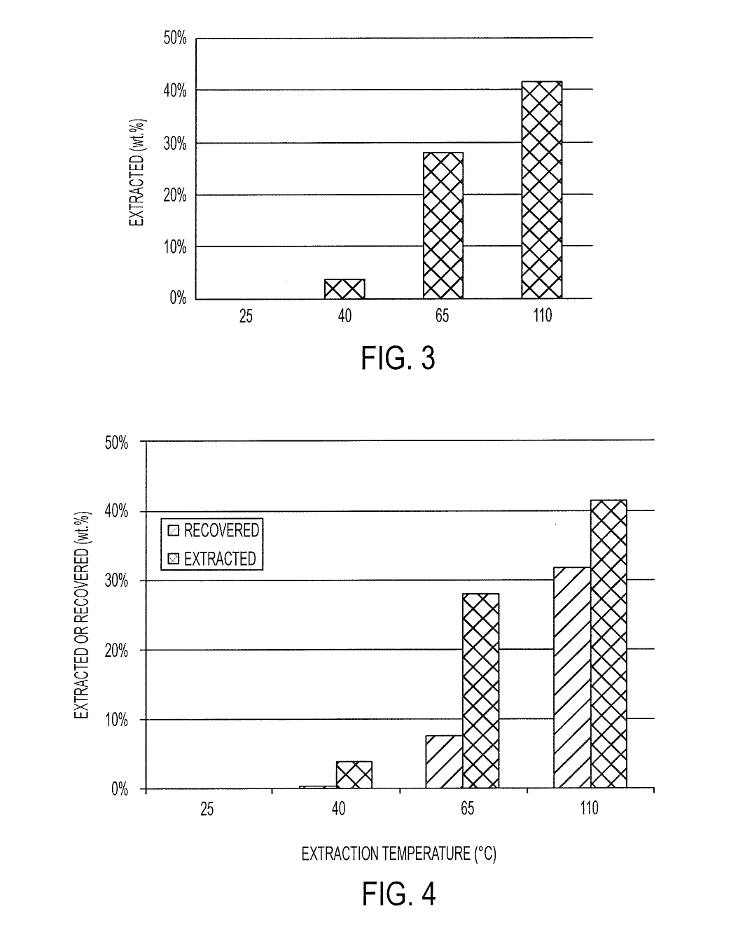

Algae (Scenedesmus dimorphus) were grown and thermochemically converted to bio-oil by pyrolysis at 475° C. Samples of the bio-oil were subjected to extraction using supercritical propane at different temperatures (25° C., 40° C., 65° C., 110° C.). The samples were analyzed to determine the amount (by wt %) of bio-oil fraction extracted at each temperature. As shown in FIG. 3, the extraction using supercritical propane at 65° C. and 110° C. had higher yields of the bio-oil fraction than that conducted at 25° C. and 40° C.

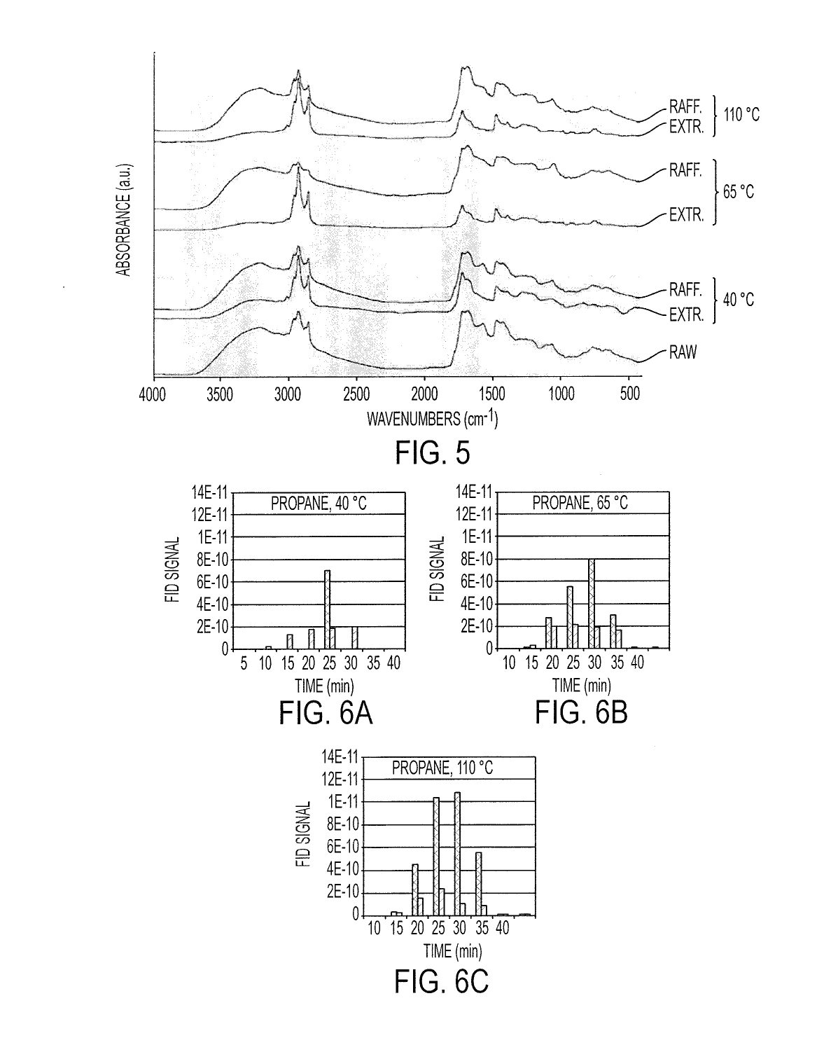

Algae (Scenedesmus dimorphus) were grown and thermochemically converted to bio-oils by pyrolysis at 475° C. Samples of the bio-oil were subjected to extraction using supercritical propane at different temperatures (25° C., 40° C., 65° C., 110° C.). The samples were analyzed to determine the amount (by wt %) of extracted and recovered bio-oil fraction at each temperature. As shown in FIG. 4, the extractions at 65° C. and 110° C. resulted in the highest amount of extracted and recovered bio-oil fraction. The samples extracted at 40° C., 65° C., and 110° C. were also subjected to IR analysis, as shown in FIG. 5, and GC analysis, as shown in FIGS. 6a-6c. The IR and GC data show that the extracts and raffinates are chemically different from one another.

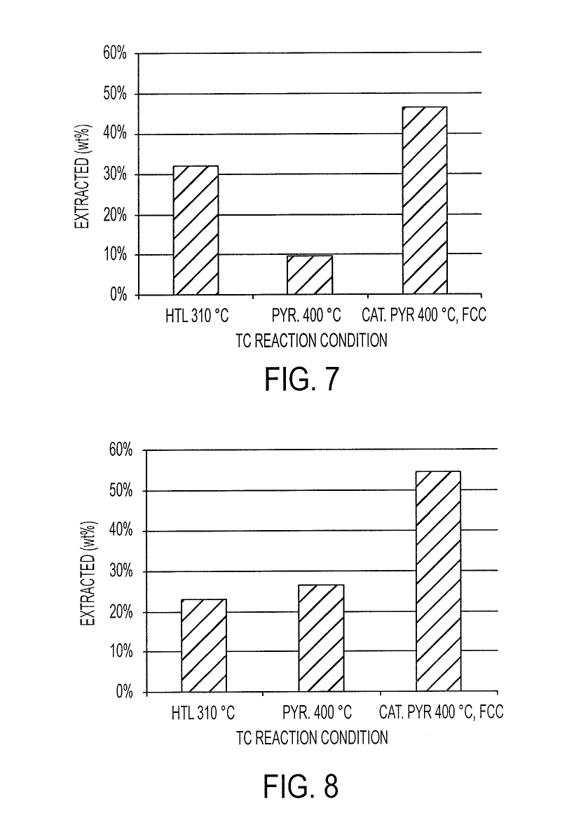

Algae (Scenedesmus dimorphus) were grown and thermochemically converted to bio-oils by HTL at 310° C., pyrolysis at 400° C., and FCC pyrolysis at 400° C. Samples of the bio-oils were subjected to extraction using supercritical propane at 65° C. The samples were analyzed to determine the amount (by wt %) of bio-oil fraction extracted following each different type of thermochemical process. As shown in FIG. 7, the bio-oil produced by FCC pyrolysis at 400° C. had the highest amount of bio-oil fraction extracted.

Algae (Scenedesmus dimorphus) were grown and thermochemically converted to bio-oils by HTL 310° C., pyrolysis at 400° C., and FCC pyrolysis at 400° C. Samples of the bio-oil were subjected to extraction using supercritical CO₂ at 65° C. The samples were analyzed to determine the amount (by wt %) of bio-oil fraction extracted following each different type of thermochemical process. As shown in FIG. 8, the bio-oil produced by FCC pyrolysis at 400° C. had the highest amount of bio-oil fraction extracted.

The pyrolysis, FCC pyrolysis, and HTL studies clearly showed that there were significant differences in the compositions of the bio-oils produced from each of the processes. The qualities of the bio-oils were different and their oxygen contents were considerably different. The pyrolysis and the HTL oils were both highly viscous, nearly solid tar-like substances, whereas the FCC pyrolysis bio-oils were free flowing liquids with relatively low viscosity. Further, the extraction of the FCC pyrolysis oil with supercritical fluids was superior to the those of the other thermochemical processes. The bio-oils produced by FCC pyrolysis at 400° C. were more extractable using supercritical fluids than the bio-oils produced by the other thermochemical processes.

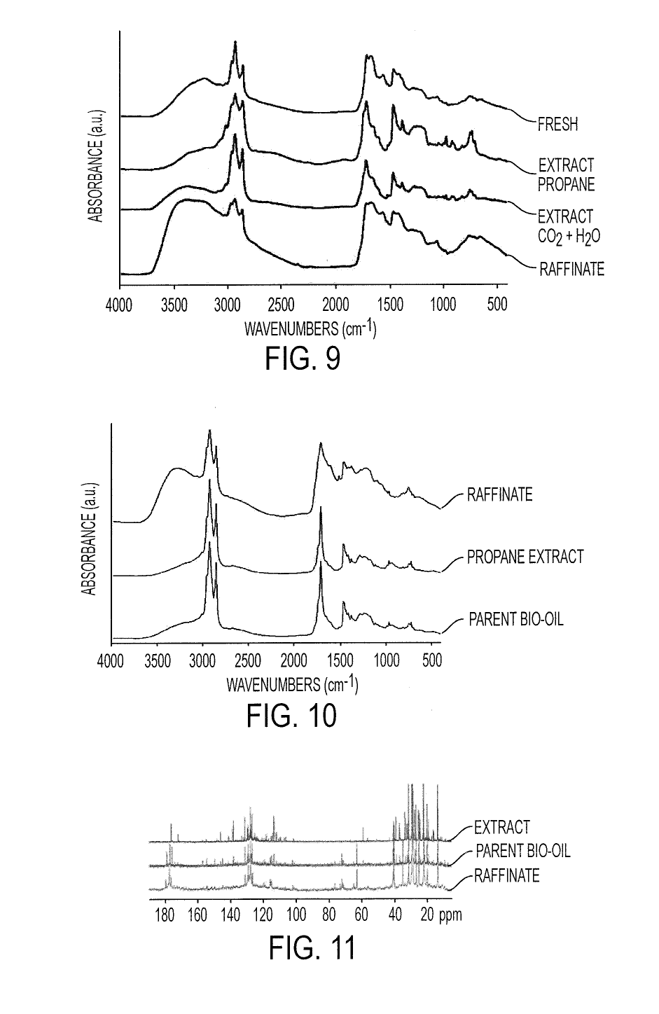

Algae (Scenedesmus dimorphus) were grown and thermochemically converted to bio-oils by FCC pyrolysis at 400° C. Samples of the bio-oil were subjected to extraction using supercritical propane and supercritical carbon dioxide. The samples were subjected to IR analysis to determine the components of the bio-oil in each fraction. As shown in FIG. 9, the bio-oil, bio-oil extracted with supercritical propane, the bio-oil extracted with supercritical carbon dioxide, and the raffinate were chemically different from one another.

### Example 4

### Extraction of Bio-Oils from Algal Biomass Using Near-Critical Propane

Catalytic pyrolysis oils were produced from Scenedesmus dimorphus algae using FCC pyrolysis. The catalytic pyrolysis studies were conducted in a 4 kg/h pilot scale fluidized bed pyrolysis reactor. The catalyst used was a proprietary material supplied by BASF Inc. (FCC 6705). The FCC catalyst was used as both heat transfer medium and catalyst. About 1000 g of the FCC catalyst was used per run and dried S. dimorphus algae biomass ground to pass 2-mm mesh was used for the studies. The pyrolysis unit consisted of a Brabender hopper and screw feeder, fluidized bed reactor, hot gas filter, two condensers (whose temperatures are maintained using water and ethylene glycol mixture), Venturi scrubber, electrostatic precipitator (ESP), coalescing filter, and gas compressor to recirculate the pyrolysis gases. The reactor was externally heated through a three-zone electric furnace. The FCC pyrolysis was carried out at 400° C.

Preliminary extraction experiments demonstrated that near-critical propane was an appropriate solvent for the extraction of the bio-oil produced from this algal feedstock. Supercritical propane extraction was performed at 65° C. at a fluid reduced pressure of 2.0 (85 bar) using an eight to one solvent to feed ratio by weight. About 83% of the bio-oil was extracted using propane, leaving about 17% as raffinate.

Sequential use of supercritical carbon dioxide after the near-critical propane showed that only a minimum additional amount (about 3%) was extracted. Using carbon dioxide alone did not seem to separate fractions of different composition as determined by IR analyses. In contrast, supercritical propane extracts were different from the parent bio-oil. For example, elemental analyses (as shown in Table 1) showed that the content of nitrogen in the fraction extracted with near-critical propane was about half of the original nitrogen present in the parent bio-oil. The near-critical propane extract also had a lower viscosity than the parent bio-oil, as shown in Table 2, where the viscosity (cP) was measured at different temperatures.

TABLE 1
Elemental Analysis of Parent and Extracted Bio-oils.

| Sample | H/C mol ratio | N/C mol ratio |
|---|---|---|
| Parent bio-oil | 1.700 | 0.013 |
| Propane extract | 1.791 | 0.007 |

TABLE 2
Viscosity (cP) at different temperatures.

| | 30° C. | 40° C. | 60° C. | 80° C. |
|---|---|---|---|---|
| Parent bio-oil | 8.07 | 4.66 | 1.80 | <1 |
| Propane extract | 6.76 | 4.28 | 1.79 | <1 |

IR analyses (FIG. 10) of the parent bio-oil, near-critical propane extracted bio-oil, and raffinate showed that aliphatic chains (peaks within the 2600-3100 cm⁻¹) and low-polarity carbonyl-containing species, such as ketones and/or esters (1700 cm⁻¹), were preferentially extracted with near-critical propane while hydrogen bonded, —OH species (broad band around 3000 cm⁻¹) were preferentially left in the raffinate. In addition, higher-polarity, carbonyl-containing species such as acids, amides, and alcohols, were also left in the raffinate.

The IR findings were confirmed by NMR analyses of the parent bio-oil, near-critical propane extracted bio-oil, and raffinate, as shown in FIG. 11 and Table 3. ¹³C NMR analyses of the samples are shown in FIG. 11 and

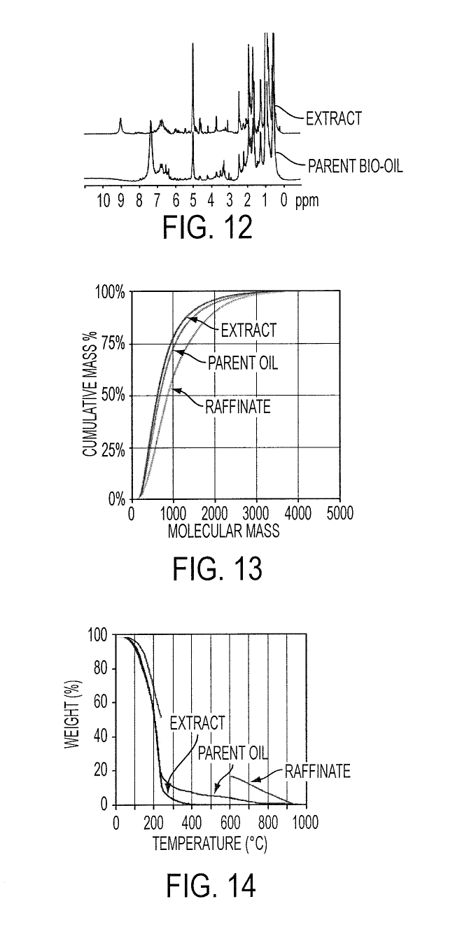

Table 3. Carbonyl and C—O contributions are higher in the raffinate, while C—C—C contribution is higher in the near-critical propane extracted bio-oil. ¹H NMR analyses are shown in FIG. 12 and Table 4. Exchangeable OHs are reduced in the near-critical propane extracted bio-oil. These exchangeable OHs include water, carboxylic acids, and many alcohols.

TABLE 3
Percent Contribution of Different Species Estimated from ¹³C NMR
Analyses Areas in FIG. 11.

| | ¹³C NMR | | Parent bio- | |
|---|---|---|---|---|
| | Range | Propane extract | oil | Raffinate |
| C═O | 215-166.5 ppm | 2.1% | 8.0% | 8.3% |
| aromatic | 166.5-95.8 ppm | 33.4% | 33.0% | 35.9% |
| C—O | 95.8-55.2 ppm | 1.8% | 4.5% | 8.1% |
| C—C—C | 55.2-0 ppm | 62.7% | 54.4% | 47.7% |

TABLE 4
Percent Contribution of Different Species estimated from ¹H NMR
Analyses Areas in FIG. 12.

| | Parent bio-oil | Propane extract |
|---|---|---|
| Exchangeable OH | 8.0% | 1.8% |
| All other protons | 92.0% | 98.2% |

MALDI-TOF analyses (FIG. 13) showed that the near-critical propane extracted bio-oil had a lower average molecular weight than the parent bio-oil, and the raffinate had a higher average molecular weight. The near-critical propane extracted bio-oil was also more volatile as measured by temperature programmed volatilization under flowing helium (FIG. 14). About 80% of the parent bio-oil and near-critical propane extracted bio-oil volatilized below 250° C. The remaining 20% of the original oil mass required higher temperatures for the parent bio-oil than for the near-critical propane extracted bio-oil. The raffinate seemed to be much more active when heated and sudden bursts of volatiles did not allow for a steady profile even at the low heating rate of 1 K/min that was applied, which resulted in the incomplete curve in FIG. 14 for the raffinate sample. The raffinate required temperatures above 500° C. for the last 20% to volatilize.

### Example 5

### Thermal Aging of Bio-Oil, Near-Critical Propane Extracted Bio-Oil, and Raffinate

Samples of the bio-oil, near-critical propane extracted and raffinate were submitted to accelerated aging, which included keeping bio-oil aliquots in closed vials for 24 hours and 2 weeks at 80° C. The aged samples were analyzed to determine the effects of aging on sample physicochemical properties.

Table 5 shows the results of viscosity measurements at different temperatures (30° C., 40° C., 60° C., 80° C.). For example, the viscosity at 30° C. of the parent bio-oil, which was 8.07 cP when fresh, became 68.1 cP after 2 weeks. In contrast, the near-critical propane extracted bio-oil, which had a viscosity of 6.76 cP when fresh, showed a viscosity of 29.6 cP after 2 weeks. In other words, the parent bio-oil viscosity increased about 8 times with aging, and the viscosity of the near-critical propane extracted bio-oil increased only 4 times with aging. The amount of raffinate collected was insufficient for viscosity analyses.

TABLE 5
Viscosity (cP) of Bio-oil, Near-critical Propane Extracted Bio-oil, and Raffinate.

| | 30° C. | | | 40° C. | | | 60° C. | | | 80° C. | | |
|---|---|---|---|---|---|---|---|---|---|---|---|---|
| Sample | 0 h | 24 h | 2 weeks | 0 h | 24 h | 2 weeks | 0 h | 24 h | 2 weeks | 0 h | 24 h | 2 weeks |
| Parent bio-oil | 8.07 | 8.60 | 68.1 | 4.66 | 4.89 | 41.6 | 1.80 | 1.79 | 18.5 | <1 | <1 | 8.02 |
| Near-critical | 6.76 | 5.24 | 29.6 | 4.28 | 3.26 | 18.5 | 1.79 | 1.43 | 8.02 | <1 | <1 | 4.81 |
| propane extract | | | | | | | | | | | | |

| | |
|---|---|
| Raffinate | (N/A) |

The results showed that the bio-oil fraction obtained by near-critical propane extraction was twice as stable as the parent bio-oil, confirming that bio-oil extraction with an appropriate near critical or supercritical fluid improves bio-oil stability.

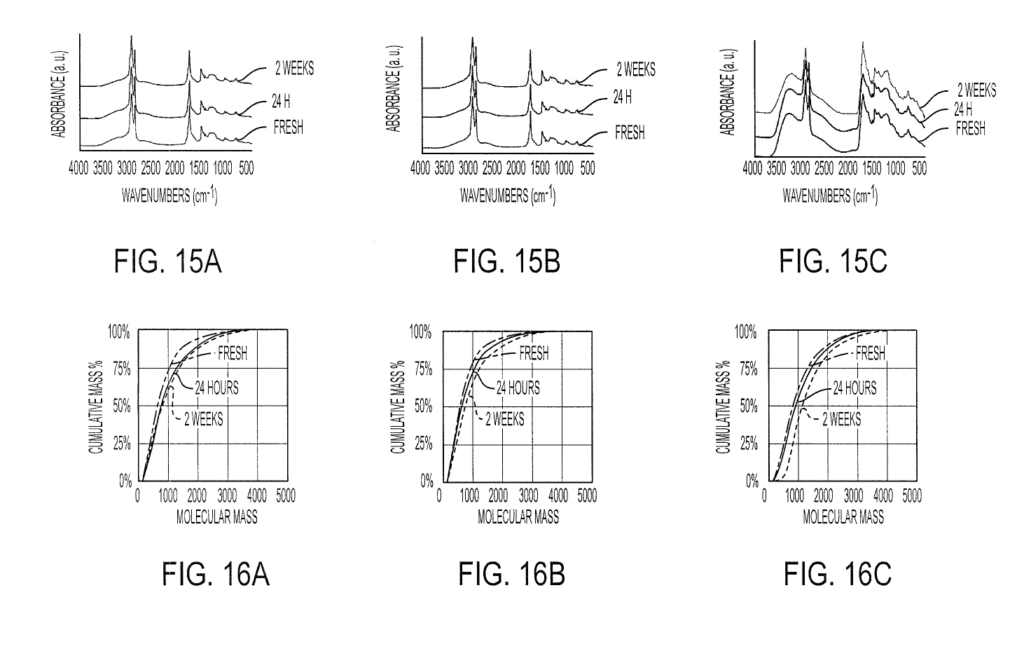

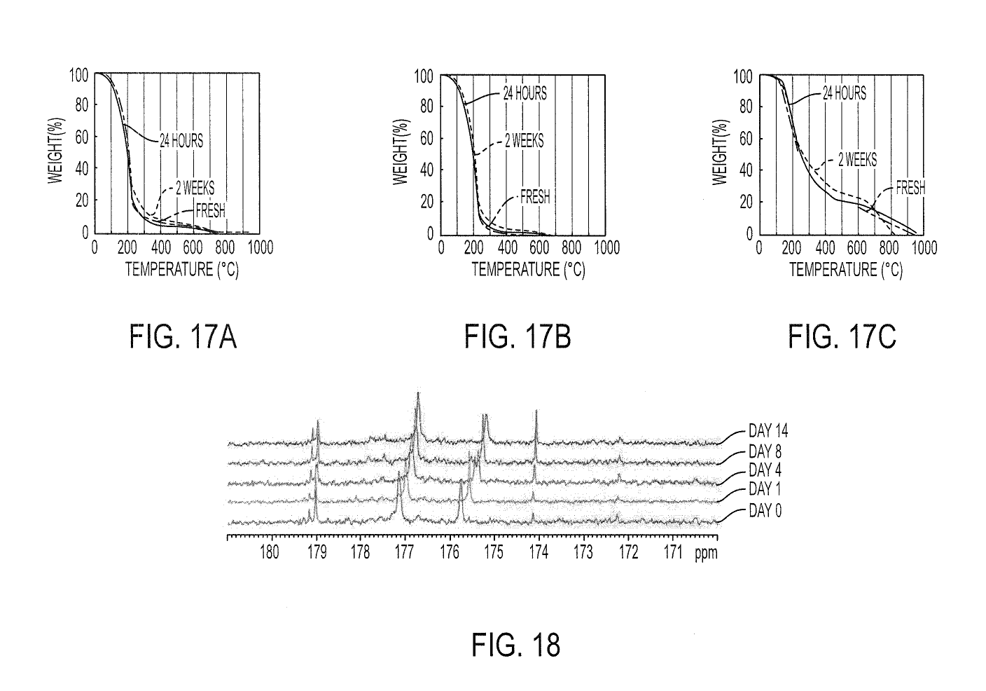

To understand the processes that affected the stability of the bio-oils, additional analyses were performed. IR analyses (FIGS. 15A-15C) performed on fresh and aged (24 hours and 2 weeks) bio-oil samples (parent bio-oil (FIG. 15A), near-critical propane extracted bio-oil (FIG. 15B), and raffinate (FIG. 15C)) did not show significant differences, indicating that the species that produced such important changes in viscosity may be present in low quantities. In FIGS. 15A-15C, the IR results of the parent bio-oil are shown on the left, the near-critical propane extracted bio-oil in the center, and the raffinate on the right. The molecular mass distribution shifted to higher molecular masses with aging in all samples (FIGS. 16A-16C). In FIGS. 16A-16C, MALDI-TOF results of the parent bio-oil are shown on the left (FIG. 16A), the near-critical propane extracted bio-oil in the center (FIG. 16B), and the raffinate on the right (FIG. 16C). In general, volatility also decreased with aging (FIGS. 17A-17C). In FIGS. 17A-17C, TGA analyses of the parent bio-oil are shown on the left (FIG. 17A), the near-critical propane extracted bio-oil in the center (FIG. 17B), and the raffinate on the right (FIG. 17C).

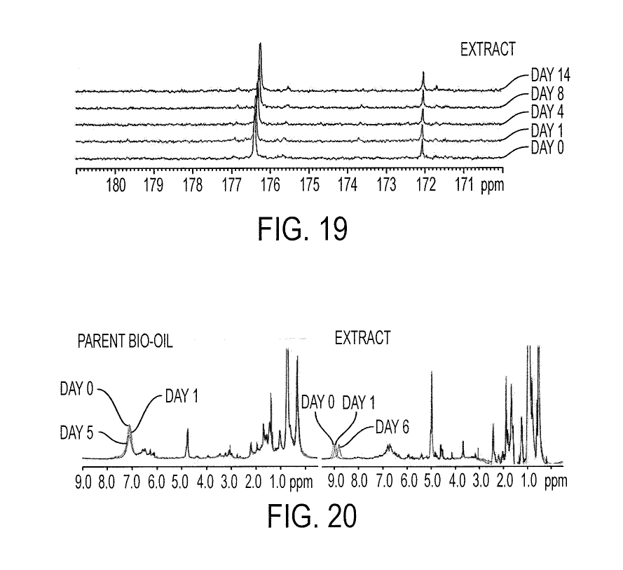

Parent bio-oil and near-critical propane extracted bio-oil were submitted to an in situ ¹H NMR and ¹³C NMR aging study for 2 weeks at 80° C. The results are shown in FIGS. 18 and 19 (¹³C NMR of bio-oil and near-critical propane extracted bio-oil, respectively), in FIG. 20 (¹H NMR of bio-oil (left) and near-critical propane extracted bio-oil (right)), and in Tables 6 and 7. The shift of the peaks was more significant in the parent bio-oil than in the near-critical propane extracted bio-oil. For example, the peak at 176-177 ppm shifted −0.45 ppm in the parent bio-oil and −0.15 in the near-critical propane extracted bio-oil. This showed that the near-critical propane extracted bio-oil was chemically more stable than the parent bio-oil. In addition, the parent bio-oil started with more exchangeable protons, which declined more rapidly with aging than the near-critical propane extracted bio-oil. The exchangeable protons in the near-critical propane extracted bio-oil displayed a downfield shift compared to the parent bio-oil suggesting a larger fraction of acid in the exchangeable protons. A general shift of the spectrum upfield with aging suggested the consumption of acid over time in both samples. This suggests that aging was likely due to polymerization of esters with alcohols in presence of acid and base that are present within the bio-oil.

TABLE 6
Changes in ¹³C NMR Peak Position between the Initial Position and
Position at 14 days corresponding to Bio-oil shown in FIG. 18.

| ¹³C NMR (Initial | | |
|---|---|---|
| ppm) | Δ ppm | Integration (%) |
| 177.2 | −0.45 | 1.1% |
| 175.8 | −0.57 | 0.6% |
| 34.8 | −0.28 | 1.5% |
| 24.7 | −0.12 | 1.2% |
| 21.7 | −0.33 | 0.8% |

TABLE 7
Changes in ¹³C NMR Peak Position between the Initial Position
and Position at 14 days corresponding to Near-critical Propane
Extracted Bio-oil shown in FIG. 19.

| ¹³C NMR (Initial | | |
|---|---|---|
| ppm) | Δ ppm | Integration (%) |
| 176.4 | −0.15 | 0.8% |

Based on the above results, extraction of the bio-oil using near-critical propane and supercritical carbon dioxide is a promising method to decrease the nitrogen content of bio-oils and to improve the stability of bio-oils obtained by the catalytic pyrolysis of algae-based biomass.

The FCC pyrolysis, non-catalytic pyrolysis, and HTL studies clearly showed that there were significant differences between the bio-oils produced by each of these processes. The qualities of the bio-oils were different and their oxygen contents were considerably different. The non-catalytic pyrolysis and the HTL oils were highly viscous, nearly solid tar-like substances, whereas the FCC pyrolysis bio-oils were free flowing liquids with relatively low viscosity. Further, the supercritical fluid extraction of the FCC pyrolysis oil was superior.

Based on energy analysis, extraction efficiency, and chemical changes among the fractions, supercritical propane was chosen as the most appropriate solvent for the extraction process. It was found that the supercritical propane extracted bio-oil was twice as stable as the parent bio-oil produced from Scenedesmus dimorphus as measured by the change in viscosity after two weeks of accelerated aging at 80° C. Further, the in situ NMR aging studies found that the supercritical propane extracted bio-oil was chemically more stable than the parent bio-oil.

It was also determined that energy for running the supercritical fluid separation process and the GHG emissions were minor compared to all the inputs to the overall well to pump system. For the well to pump system boundary, energetics in biofuel conversion are typically dominated by energy demands in the growth, dewater, and thermochemical process. Bio-oil stabilization of the supercritical propane extracted bio-oil had minimal impact in the overall energetics of the process with net energy ratio (NER) contributions of 0.03 for both conversion technologies. The overall conversion pathways were found to be energy intensive with a NER of about 2.3 and 1.2 for pyrolysis and HTL, respectively. GHG emissions for the pyrolysis process were greater than that of petroleum diesel. Microalgae bio-oil based diesel with thermochemical conversion through HTL meets renewable fuel standards with favorable emission reductions

While the disclosure may be susceptible to various modifications and alternative forms, specific embodiments have been shown by way of example in the Examples and drawings and have been described in detail herein. However, it should be understood that the disclosure is not intended to be limited to the particular forms disclosed. Rather, the disclosure is to cover all modifications, equivalents, and alternatives falling within the scope of the disclosure as defined by the following appended claims and their legal equivalents.

What is claimed is:

1. A method for separating a bio-oil, comprising:
contacting a bio-oil produced from a biomass by a thermochemical process with a supercritical alkane to dissolve non-polar compounds of the bio-oil in the supercritical alkane; and
removing the non-polar compounds from the bio-oil to produce a fractionated bio-oil comprising polar compounds.

2. The method of claim 1, wherein contacting a bio-oil with a supercritical alkane comprises contacting the bio-oil comprising alkane compounds, alkene compounds, aromatic compounds, nitrogen-containing compounds, alcohol compounds, ether compounds, aldehyde compounds, ketone compounds, phenol compounds, ester compounds, guaiacol compounds, syringol compounds, sugar compounds, furan compounds, and carboxylic acid compounds with the supercritical alkane.

3. The method of claim 1, wherein contacting a bio-oil with a supercritical alkane comprises contacting the bio-oil with supercritical ethane, supercritical propane, supercritical butane, supercritical pentane, supercritical hexane, or combinations thereof.

4. The method of claim 1, wherein contacting a bio-oil with a supercritical alkane comprises contacting the bio-oil with an alkane maintained at a temperature of from about 75° C. below a critical temperature of the alkane to about 75° C. above the critical temperature of the alkane and at a pressure of from about 0.1 times a critical pressure of the alkane to about 10 times the critical pressure of the alkane.

5. The method of claim 1, wherein contacting a bio-oil with a supercritical alkane comprises contacting the bio-oil with an alkane maintained at a temperature of greater than or equal to about 0.9 times the critical temperature of the alkane and at a pressure greater than or equal to about 0.5 times the critical pressure of the alkane.

6. The method of claim 1, wherein contacting a bio-oil with a supercritical alkane comprises flowing the supercritical alkane countercurrent to the bio-oil.

7. The method of claim 1, wherein removing the non-polar compounds from the bio-oil to produce a fractionated bio-oil comprising polar compounds comprises removing alkane compounds, alkene compounds, aromatic compounds, and nitrogen-containing compounds from the bio-oil.

8. The method of claim 1, further comprising separating the non-polar compounds into fractions of similar polarities.

9. The method of claim 8, wherein separating the non-polar compounds into fractions of similar polarities comprises adjusting at least one of the pressure and temperature of the supercritical alkane.

10. The method of claim 8, further comprising recovering each of the fractions of similar polarities.

11. The method of claim 1, further comprising separating the polar compounds into fractions of similar polarities.

12. The method of claim 11, further comprising recovering each of the fractions of similar polarities.

13. A method for method for separating a bio-oil, comprising:
converting a biomass into bio-oil by a thermochemical process;
contacting the bio-oil with a supercritical alkane to dissolve non-polar compounds of the bio-oil in the supercritical alkane;
separating the supercritical alkane comprising the dissolved non-polar compounds from the bio-oil to produce a fractionated bio-oil;
contacting the fractionated bio-oil with supercritical carbon dioxide to dissolve polar compounds of the fractionated bio-oil in the supercritical carbon dioxide;
separating the supercritical carbon dioxide comprising the dissolved polar compounds from the fractionated bio-oil; and
recovering the polar compounds from the supercritical carbon dioxide.

14. The method of claim 13, wherein contacting the bio-oil with a supercritical alkane to remove non-polar compounds from the bio-oil comprises contacting the bio-oil with near-critical propane.

15. The method of claim 13, wherein contacting the fractionated bio-oil with supercritical carbon dioxide comprises contacting the fractionated bio-oil with supercritical carbon dioxide and supercritical water.

16. The method of claim 13, wherein recovering the polar compounds from the supercritical carbon dioxide comprises adjusting at least one of a pressure and temperature at which the supercritical carbon dioxide is maintained.

17. The method of claim 13, further comprising recovering the non-polar compounds from the supercritical alkane.

18. The method of claim 13, wherein converting a biomass into bio-oil by a thermochemical process comprises converting an algal biomass into the bio-oil by the thermochemical process.
